(19) United States
(12) Patent Application Publication
(10) Pub. No.: US 2022/0144084 A1
(43) Pub. Date: May 12, 2022

(54) ENTRY RAIL FOR A VEHICLE

(71) Applicant: DAIMLER AG, Stuttgart (DE)

(72) Inventors: Christian BALLUFF, Leinfelden-Echterdingen (DE); Markus NEUBERGER, Leinfelden (DE); Richard Josef KOWATSCH, Schlierbach (DE); Frank ERHARDT, Haimhausen (DE); Michael MANZ, Ottobrunn (DE); Lars TÜRKIS-RENOUF, Taufkirchen (DE)

(21) Appl. No.: 17/434,048

(22) PCT Filed: Feb. 13, 2020
(86) PCT No.: PCT/EP2020/053679

§ 371 Date: Aug. 26, 2021

(30) Foreign Application Priority Data
Feb. 27, 2019 (DE) 10 2019 001 385.9

(51) Int. Cl. B60K 35/00; B60R 13/02

(52) U.S. Cl. CPC B60K 35/00; B60K 2370/16; B60K 2370/794; B60R 13/0243

(57) ABSTRACT

An entry rail, which can be arranged in an entry region of a vehicle door of a vehicle, includes a display unit for displaying text, images and/or videos is integrated into the entry rail. A display surface of the display unit is visible for a user when the vehicle door is open.

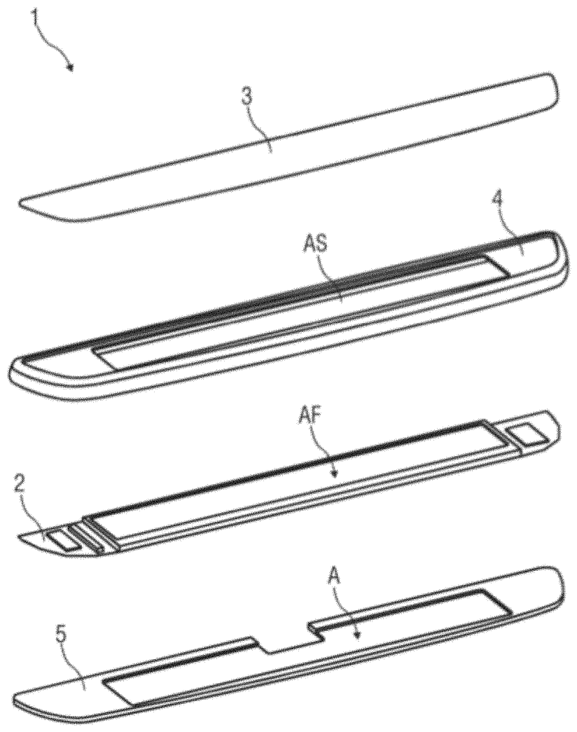

### BACKGROUND AND SUMMARY OF THE INVENTION

Exemplary embodiments of the invention relate to an entry rail for arranging in an entry region of a vehicle door of a vehicle.

EP 2 028 046 A1 discloses a decorative body with illuminable decorative elements, in particular an entry door sill trim for arranging on a bodywork of a vehicle in the region of an entry threshold. The decorative body comprises a light conductive layer, into which light can be irradiated by means of a laterally arranged illuminant, a light-covering decorative element layer arranged above the light conductive layer having regions impermeable and permeable to light, which are formed correspondingly to the decorative elements, and a reflective layer arranged below the light conductive layer. Here, the reflective layer is formed from a plurality of pixels.

Exemplary embodiments of the invention are directed to an improved entry rail over the prior art for arranging in an entry region of a vehicle door of a vehicle and a vehicle having such an entry rail.

According to the invention, a display unit for displaying text, images and/or videos is integrated into an entry rail for arranging in an entry region of a vehicle door of a vehicle, wherein a display surface of the display unit is visible for a user when the vehicle door is open.

If the user opens the vehicle door in order to get in the car, traffic information for a planned driving route of the vehicle, for example, can be displayed to the user, wherein it is alternatively or additionally possible to remind the user of an upcoming appointment and/or of matters they are involved in.

In addition, before starting up the vehicle, safety information, directions relating to a first-aid kit and/or a warning triangle, directions in the event of damage to the vehicle and/or information and/or procedural instructions in the event of an accident can be issued optically by means of the display unit.

In one design, the entry rail, which is usually also referred to as a door sill, is formed by a decorative frame and an element that is at least sectionally bordered by the decorative frame and at least regionally translucent, wherein the display unit is arranged between the support element and the decorative frame. Here, the at least regionally translucent element serves to protect the display unit from dirt, damp and, in particular, from mechanical load, such that the risk of damaging the display unit can be excluded as far as possible.

In a development, the display unit comprises at least one data interface for coupling the display unit to at least one mobile terminal and/or for coupling to at least one control unit of the vehicle. The coupling to the mobile terminal, in particular to a smartphone of a user, and/or the control unit can predetermine what is to be optically emitted by means of the display unit.

In a possible development, the at least one data interface is formed as a radio interface, such that it is not required for the predetermination of information and/or topics to be displayed to arrange and to lay cables in the vehicle.

A further embodiment provides that the entry rail has a fixing structure, which is formed to make a force-fit, firmly bonded and/or form-fit fixing to a bodywork part of the vehicle.

Here, the fixing structure is formed in such a way and the entry rail is fixed to the bodywork part in such a way that the entry rail can be dismounted from the bodywork part in a manner substantially free of damage and destruction. Thus, it is possible, for example, to exchange or remove the display unit in order to repair it in the event of reparations. The entry rail can thus be detached from the bodywork part without damage.

In addition, such an entry rail can constitute a retrofit solution for a vehicle, such that the entry rail with display unit can also be arranged retrospectively in a vehicle.

In order to protect the display unit, in particular from the appearance of dirt and/or damp, a peripheral sealing element is provided in a further possible embodiment for sealing the entry rail in relation to the bodywork part.

Moreover, the invention relates to vehicle having at least one such entry rail, wherein information, for example relating to the weather conditions, upcoming appointments, information relating to the road holding and/or a welcome message, can be emitted optically to the user by means of the display unit.

Exemplary embodiments of the invention are explained in more detail below by means of a drawing.

### BRIEF DESCRIPTION OF THE DRAWING FIGURE

The sole FIGURE schematically illustrates a perspective view of an exploded depiction of an entry rail for arranging in an entry region of a vehicle door of a vehicle.

### DETAILED DESCRIPTION

The single FIGURE shows a perspective view of an exploded depiction of an entry rail 1 for arranging in an entry region of a vehicle door, not depicted in more detail, of a vehicle, also not depicted in more detail.

In order to be able to optically emit to a user, upon opening the vehicle door, an individual welcome message, for example, weather conditions in the immediate surroundings of the vehicle, an upcoming appointment and/or information relating to a current traffic state, a display unit 2 with an electronic system necessary for its operation and at least one data interface is integrated into the entry rail 1.

The entry rail 1 comprises a translucent element 3, which is black when the display unit 2 is inactive, a decorative frame 4, the display unit 2, and a support element 5.

The support element 5, which can also be referred to as a base plate of the entry rail 1, has a receiver A for arranging the display unit 2, wherein regions of the display unit 2 are arranged inside the receiver A and other regions, in particular parts of the electronic system, abut on the support element 5 on the edge side.

The decorative frame 4 has a recess AS is arranged above the display unit 2 arranged on the support element 5, such recess bordering the display unit 2, wherein an edge region of the decorative frame 4 projects out from a surface of the decorative frame 4 by a predetermined amount, which corresponds, in particular, to a thickness of the translucent element 3.

The translucent element 3, which is formed to be discoid, can be arranged on the decorative frame 4, wherein the edge region of the decorative frame 4 surrounds and borders the translucent element 3.

In the assembled state, the entry rail 1 forms a compact unit, wherein the support element 5, the display unit 2, the decorative frame 4, and the translucent element 3 are connected to one another in a form-fit and force-fit manner. For example, a clip and/or latch connection is provided for this, such that a dismounting of the entry rail 1 is possible in a manner that is substantially free of damage and destruction. In particular, it is necessary to dismount the entry rail 1 in order to be able to exchange the display unit 2 in the event of a defect, for example. The entry rail 1 thus forms a compact exchangeable or retrofittable unit as a result of its modular construction.

In one design, the support element 5, the display unit 2, the decorative frame 4, and the translucent element 3 are connected to one another in a form-fit and force-fit manner in such a way that the compact unit is formed tightly in relation to the entry of dirt and/or damp.

Alternatively, or in addition to the form-fit and force-fit fixing, a firmly bonded connection can also be provided, which also enables separation without damage.

Nevertheless, it can be provided that at least one peripheral sealing element not shown in more detail is arranged between the translucent element 3 and the decorative frame 4, wherein a sealing element can also be arranged between the decorative frame 4 and the display unit 2 and/or between the display unit 2 and the support element 5.

In particular with the arrangement of the entry rail 1 between the support element 5 and a bodywork part forming the entry rail, a so-called sill, a sealing element can be arranged for sealing the entry rail 1 in relation to the bodywork part. Thus, it can be at least extensively precluded that dirt and/or water penetrate(s) between the entry rail 1 and the bodywork part.

In order to fix the entry rail 1 on the bodywork part, the form-fit and force-fit fixing is also suitable, such that it can be implemented in the event of repairing the display unit 2, for example, to remove the entry rail 1 comparably easily from the bodywork part.

However, it is also conceivable, alternatively, or additionally, to fix the entry rail 1 in a firmly bonded manner on the bodywork part.

Via the at least one data interface of the display unit 2, this can be coupled to a mobile terminal of the user, in particular a smartphone, and/or to a control unit of the vehicle, such that a configuration of the display unit 2 can be undertaken by the user. For this, the data interface can be formed as a radio interface. For example, with a corresponding coupling, the user has the opportunity to predetermine what content can be optically emitted on a display surface AF of the display unit 2. Thus, it is possible, in particular, to optically emit text, images, and/or videos.

For example, an alignment of content emitted by means of the display unit 2 can change when it can be ascertained whether the user of the vehicle, in particular a driver, is getting into the vehicle or getting out of it.

In particular, a control of the display unit 2 is carried out via an application program saved on the mobile terminal and/or via an actuation of an infotainment system, i.e., via an instrument tablet of the vehicle, wherein, to do so, at least one actuation element is provided.

In one embodiment, the entry rail 1 with the integrated display unit 2 in an entry region is arranged on a driver side of the vehicle, wherein such an entry rail 1 can also be arranged in an entry region on a passenger side of the vehicle.

By means of an entry rail 1 formed in such a way, the integrated display unit 2 of which can be configured by the user, for example by means of their smartphone, a high degree of individuality is created, since the displayed welcome message, for example, can be adjusted in relation to the time of day, wherein an alignment of the welcome message on the display surface AF of the display unit 2 can be set. For example, a vehicle silhouette and/or a type identifier of the vehicle can be optically emitted.

If the vehicle is a specific vehicle category, different depictions can also be chosen, such that a sports car silhouette can be displayed. If the vehicle is an electric vehicle, a hybrid vehicle or a vehicle powered with fuel cells, a charging state of an electrical energy store, for example, can be displayed.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. An entry rail configured to be affixed in an entry region of a vehicle door of a vehicle, the entry rail comprising:
an integrated display unit configured to display text, images, or videos, wherein a display surface of the display unit is visible for a user when the vehicle door is open.

11. The entry rail of claim 10, further comprising:
a support element;
a decorative frame; and
an element that is at least sectionally bordered by the decorative frame and at least regionally translucent, wherein the display unit is arranged between the support element and the decorative frame.

12. The entry rail of claim 10, wherein the display unit comprises at least one data interface configured to couple the display unit to at least one mobile terminal or to at least one control unit of the vehicle.

13. The entry rail of claim 12, wherein the at least one data interface is a radio interface.

14. The entry rail of claim 10, further comprising:
a fixing structure, which is configured to make a force-fit, firmly bonded, or form-fit fixing on a bodywork part of the vehicle.

15. The entry rail of claim 14, wherein the fixing structure is configured in such a way that the entry rail is detachable from the bodywork part without damage.

16. The entry rail of claim 14, further comprising:
a peripheral sealing element for sealing the entry rail in relation to the bodywork part.

17. The entry rail of claim 10, wherein the display unit is configured to display weather information, upcoming appointments, a welcome message.

18. A vehicle, comprising:
a door arranged in an entry region of the vehicle; and
an entry rail arranged in the entry region of the vehicle, wherein the entry rail comprises an integrated display unit configured to display text, images, or videos, wherein a display surface of the display unit is visible for a user when the vehicle door is open.
